(19) United States
(12) Patent Application Publication
(10) Pub. No.: US 2008/0259315 A1
(43) Pub. Date: Oct. 23, 2008

(54) Composition and Method for Indicating a Certain UV Radiation Dose

(76) Inventor: Frank Mersch, Leichlingen (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/058,866

(22) Filed: Mar. 31, 2008

Related U.S. Application Data
(60) Provisional application No. 60/913,365, filed on Apr. 23, 2007.

(30) Foreign Application Priority Data
Apr. 18, 2007 (DE) 102007018605.5

(51) Int. Cl. G01J 3/00

(52) U.S. Cl. 356/51

(57) ABSTRACT

A method for indicating a certain UV radiation dose, using a mixture of substances, containing a substance of defined UV photoactivity, a redox dye and a substance acting as a sacrificial electron donor, exposing the mixture to UV radiation and detecting a defined color change when a certain UV radiation dose is reached.

### RELATED APPLICATIONS

This application claims the benefit of U.S. Provisional Patent Application Ser. No. 60/913,365 filed Apr. 23, 2007 and the benefit of German Patent Application Serial No. DE 10 2007 018 605.5 filed Apr. 18, 2007.

### TECHNICAL FIELD OF THE INVENTION

The invention relates to a composition and a method for indicating a certain UV radiation dose, as well as an auxiliary agent for its use. The method is suitable for avoiding skin damage caused by sunlight, for controlling the curing of UV-reactive coatings or plastics, and for adjusting UV optical systems.

### BACKGROUND OF THE INVENTION

It is known that ultraviolet radiation, such as contained in sunlight, can lead not only to photo-erythema and sunburn on human skin, but also, under certain circumstances, to skin cancer, if the exposure to UV radiation lasts long enough. However, there are various skin types with different degrees of sensitivity to UV radiation. Moreover, the start of sunburn is generally not directly detectable on the skin during exposure to UV radiation, but only some time later. It is thus important to detect the point in time of exposure to a certain radiation dose.

Various indicators are known for determining UV irradiation in order to avoid sunburn. In most cases, UV-sensitive dyes are used that display a—continuous—color change when exposed to UV radiation (photochromic substances). According to U.S. Pat. No. 5,117,116, for example, oxazolidinedione compounds, xanthenone compounds or tetrazolium salts are used as photochromic substances. In this context, dyes with irreversible color changes are more advantageous than those with reversible color changes, since the cumulative UV irradiation is detected in this way, even if sunbathing is interrupted.

To take into account the UV sensitivity of different skin types, the corresponding UV doses have to be correlated with different color graduations with the range of the color change of the photochromic substance. According to U.S. Pat. No. 5,117,116, corresponding UV-stable color references are used in the test device to this end, in parallel with the test substance.

U.S. Pat. No. 5,589,398 discloses a test system for the acting UV radiation that is similarly based on the color change of a photochromic substance and where the photochromic substance is applied to a test strip in a matrix. Here, too, extensive reference color scales are necessary in order to take into account the different sensitivity of the skin types and permit estimation of the possible length of time that can be spent in the sun without sunburn occurring.

The above-mentioned methods are based on a photo-oxidation reaction of the dye. A further common feature of the methods indicated is that the “photoactivity” of the photochromic substance serving as an indicator for the acting UV radiation cannot be varied, meaning that different UV radiation doses can only be determined on the basis of continuous color changes.

Also known is a method for determining the photocatalytic activity of self-cleaning coatings, where a mixture of the redox dye resazurin and glycerine is used (A. Mills et al.: “Method of Rapid Assessment of Photocatalytic Activities of Self-Cleaning Films”, J. Phys. Chem. B 2006, Vol. 110, No. 37, pp. 18324-18331). This method is based on a photoreduction reaction.

### SUMMARY OF THE INVENTION

The present invention includes a method by which a predefined UV radiation dose is simply indicated by an unequivocal change in the color of a test substance, much like the change of color with pH indicator paper.

The present invention includes a method for indicating a certain UV radiation dose, using a mixture of substances, containing a substance of defined UV photoactivity, a redox dye and a substance acting as a sacrificial electron donor, exposing the mixture to UV radiation and detecting a defined visually detectable color change when a certain UV radiation dose is reached.

### BRIEF DESCRIPTION OF THE DRAWINGS

For a more complete understanding of the present invention and for further advantages thereof, reference is now made to the following description taken in conjunction with the accompanying drawings in which:

FIG. 1 is a graph of absorption spectra, and

FIG. 2 is a graph of absorption vs time.

### DESCRIPTION OF THE PREFERRED EMBODIMENTS

The indicator action of the composition used with the present invention is probably based on the UV-induced reduction reaction postulated in the aforementioned publication by A. Mills et al.: positive holes created in the photoactive substance due to exposure to UV radiation react irreversibly with the electron donor, forming reducing electrons and/or radicals, which in turn effect the change in the color of the redox dye. Moreover, direct reduction of the redox dye by the photoactive substance is also possible.

Suitable as sacrificial electron donors are water-miscible, organic compounds of low volatility, e.g. alcohols, ketones and, in particular, glycerine. Redox dyes, include, for example, both reversibly and irreversibly decomposing dyes. Methylene blue, for example, reacts reversibly under exclusion of oxygen, whereas resazurin, for example, is decomposed irreversibly. Other suitable dyes are, for example, rhodamine or reactive dyes. Particularly for use as a sunburn warner, an irreversibly reacting redox dye is preferable.

According to the invention, a photocatalyst, preferably titanium dioxide, particularly anatase or rutile, with appropriately adapted UV photoactivity is used to indicate UV radiation doses of different strengths.

A person skilled in the art knows from titanium dioxide pigment technology how the photoactivity or photostability of titanium dioxide can be set, e.g. by varying the crystal modification (anatase/rutile), doping the crystal lattice, or applying inorganic surface coatings. A TiO₂ of low photostability, e.g. an anatase, is used to determine relatively low UV radiation doses. In contrast, high UV radiation doses are determined using a more photostable TiO₂ (rutile), which can, for example, be doped with aluminium and/or provided with a dense SiO₂ skin.

In a preferred embodiment of the invention, resazurin is used as the irreversibly reacting dye and glycerine as the sacrificial electron donor. According to the invention, the composition contains at least about 1% by weight TiO₂, at least about 5 ppm by weight resazurin and at least about 1% by weight glycerine. A preferred composition contains about 5% to 50% by weight TiO₂, about 100 ppm to 1,000 ppm by weight resazurin and about 5% to 50% by weight glycerine.

The composition can furthermore contain a substance that maintains the pH value of the composition constant to within about ±0.5 in the pH value range from 7 to 10, e.g. a dihydrogenphosphate/hydrogenphosphate buffer for the pH value 7.2 or a borate buffer for the pH value 9.2.

When using resazurin as the redox dye, a pronounced change in the color of the composition, from blue to magenta-pink, occurs when the defined UV radiation dose is reached. Use of a color reference is useful for visual evaluation.

The quantity of dye is decisive for the color impression in the composition. The quantity of TiO₂, or the photoactivity of the TiO₂, determines the speed of the change in color. In relation to the dye, an excess of the electron donor substance should be present, so that it does not have a limiting effect on the reaction. The ratio of electron donor to dye should preferably be at least roughly 100. The UV-induced reduction reaction postulated by A. Mills et al. requires the presence of OH ions. In the composition according to the invention, the water adsorbed on the surface of the feed materials usually suffices to enable the reaction to run.

For practical application, the composition according to the invention—mixed, where appropriate, with water, water-soluble organic compounds and/or fillers, such as chalk and/or kaolin—is applied to a substrate. Suitable substrates include, for example, paper, plastic film, fabric, film, non-wovens, glass or a metal not acting as a redox partner. Iron, in particular, is not suitable as a metallic substrate. The coated substrate can, for example, take the form of a test strip or an adhesive plaster.

The layer thickness of the composition on the substrate should be at least about 5 μm, preferably 50 μm to 2,000 μm, particularly 50 μm to 150 μm. Thicker layers result in diffusion of unreacted dye from deeper levels and thus delay the detectable change in color.

### APPLICATION

The mixture according to the invention can be used in various fields as an indicator for certain radiation doses, e.g., for example, as a sunburn warner, for adjusting UV optical systems, or for controlling the radiation dose for UV-curing coatings or adhesives. All other potential fields of application not listed here are to be taken as included in the scope of the invention.

### Sunburn Indicator

As regards sensitivity to sunlight, a distinction is usually made in Central Europe between four skin types that display different self-protection times. The self-protection time is defined as the maximum period of time for which the unprotected skin can be exposed to the sun in the course of a day without turning red. For application of the composition according to the invention as a sunburn warner, those UV-active titanium dioxide grades are selected that, when subjected to standardised UV irradiation, cause a change in color after the time corresponding to the standardised self-protection time of the respective skin type. In the event of more intensive irradiation, the change in color will occur earlier in the same composition, as will reddening of the skin. On the other hand, covering the composition according to the invention with sunscreen is capable of prolonging the period of time until the color changes, and equally the sunburn-free period for the skin treated with the same sunscreen.

As a sunburn warner, the indicator test strip can advantageously display several indicator compositions next to each other, corresponding to the different skin types.

### UV-Curing Coatings and Adhesives

In UV-curing coatings or adhesives, low-molecular systems are cross-linked (polymerised) by exposure to UV radiation. Exact control of the wavelength and the radiation dose is important for effective curing. The indicator according to the invention can be used for checking the UV emitters by exposing the indicator composition instead of the UV-curing coating or UV-curing adhesive. Any fault in the dose rate of the emitters can be determined on the basis of the point in time of the change in color.

### UV Optical Systems

UV optical systems can be adjusted with the help of the indicator according to the invention. Compared to the use of cards to check the beam path, the indicator according to the invention permits assessment of the radiation intensity, this normally being difficult with fluorescent systems. Since the color change of the indicator composition is irreversible, it can also be used to adjust pulsed lasers.

### EXAMPLE

The invention is explained on the basis of the example below, although this example is not intended to restrict the invention.

A basic color paste was prepared using the following components:

272 g chalk (Omyacarb 5)
140 g kaolin (Satintone Whitetex)
58 g distilled water
204 g glycerine
0.16 g resazurin

The components were thoroughly mixed with a laboratory mixer. 1 g powdery TiO₂ was added to 15 g basic color paste and made into a paste on an automatic muller. Color pastes containing TiO₂ were prepared in parallel using three different titanium dioxide grades (1, 2, 3), where 1 was an untreated anatase, 2 an untreated rutile (chloride process) and 3 an Al/Si-treated rutile (sulphate process). The color pastes were each applied with an identical layer thickness (approx. 2 mm) between two glass plates. A Lambda 950 UV-VIS spectrometer from Perkin Elmer was used to measure the spectra as a function of the duration of exposure to UV light. The reflection of the specimens was measured on an Ulbricht sphere with gloss trap. The device was calibrated using a certified Spectralon reference.

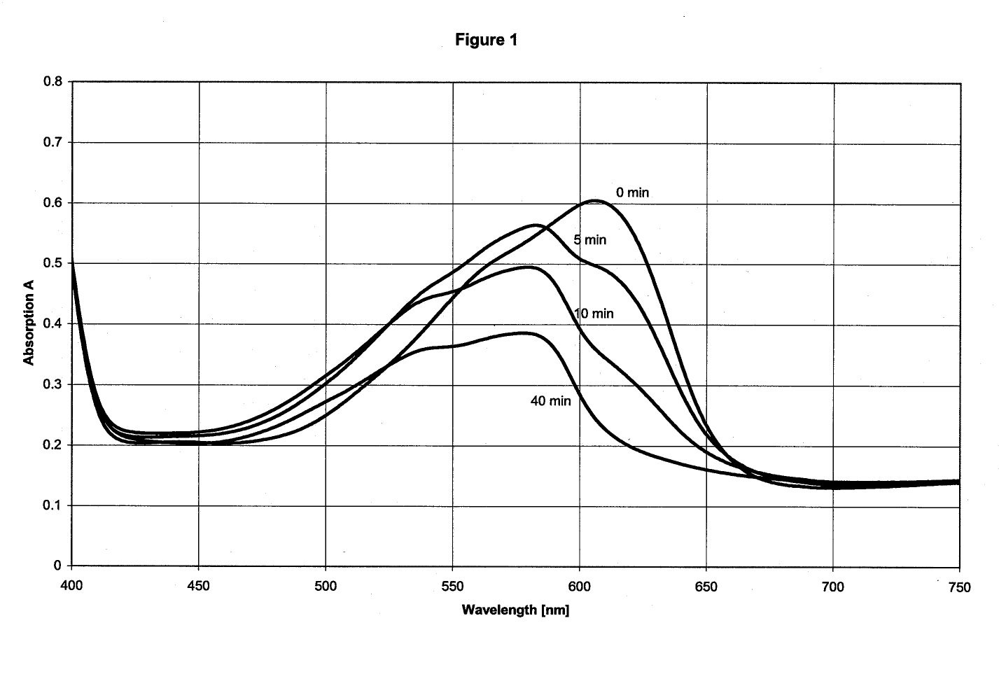

The spectra were evaluated on the basis of the change in absorption A in the wavelength range from 602 nm to 608 nm, in which the visually detectable change in color from blue to magenta-pink is particularly pronounced. As an example, FIG. 1 shows the respective absorption spectra of color paste No. 3 at different points in time. The absorption A at a specific wavelength is obtained from A=−Ig₁₀(I/I₀), where I₀=intensity upstream of the specimen and I=intensity downstream of the specimen.

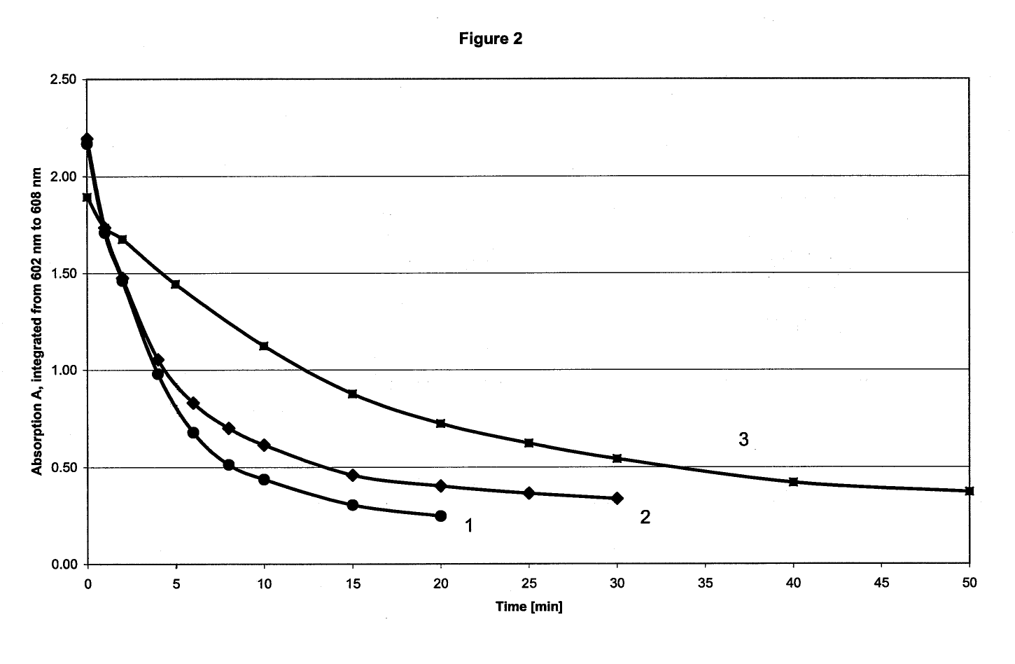

FIG. 2 shows the change in absorption A in the wavelength range from 602 to 608 nm over time for the three TiO₂-containing color pastes, where integration over the wavelength range from 602 nm to 608 nm was performed in each case to minimise artifacts resulting from noise during measurement.

The change in the color of the color paste from blue to magenta-pink is completed at A roughly=0.5. With the given UV irradiation, the following times for the change in color are thus obtained for color pastes 1, 2 and 3 (FIG. 2): 1—approx. 8 min, 2—approx. 14 min, 3—approx. 33 min.

I claim:

1. A method for indicating a certain UV radiation dose, comprising:
presenting a mixture of substances, containing a substance of defined UV photoactivity, a redox dye and a substance acting as a sacrificial electron donor;
exposing the mixture of substances to UV radiation; and
detecting a defined color change when a certain UV radiation dose is reached.

2. The method of claim 1, whereby
the substance of defined UV photoactivity is titanium dioxide.

3. The method of claim 2, whereby
the titanium dioxide is anatase.

4. The method of claim 2, whereby
the titanium dioxide is rutile.

5. The method of claim 1, whereby
the redox dye is resazurin.

6. The method of claim 1, whereby
the sacrificial electron donor is glycerine.

7. The method of claim 1, whereby
the mixture of substances contains
at least about 1% by weight titanium dioxide,
at least about 5 ppm by weight resazurin and
at least about 1% by weight glycerine.

8. The method of claim 1, whereby
the mixture of substances contains
about 5% to 50% by weight titanium dioxide,
about 100 ppm to 1,000 ppm by weight resazurin and about 5% to about 50% by weight glycerine.

9. The method of claim 1, whereby
the mixture of substances contains a substance that maintains the pH value of the mixture of substances constant to within bout±0,5 in the pH value range from about 7 to 10.

10. The method of claim 1 further including:
applying the mixture of substances to a substrate.

11. A method for indicating a certain UV radiation dose as a sunburn indicator, comprising:
presenting a mixture of substances, containing a substance of defined UV photoactivity, a redox dye and a substance acting as a sacrificial electron donor;
exposing the mixture of substances to UV radiation; and
detecting a defined color change when a certain UV radiation dose is reached.

12. A method for adjusting UV optical systems, comprising:
presenting a mixture of substances, containing a substance of defined UV photoactivity, a redox dye and a substance acting as a sacrificial electron donor;
exposing the mixture of substances to UV radiation; and
detecting a defined color change when a certain UV radiation dose is reached.

13. A method for checking UV radiation emitters, comprising:
presenting a mixture of substances, containing a substance of defined UV photoactivity, a redox dye and a substance acting as a sacrificial electron donor;
exposing the mixture of substances to UV radiation; and
detecting a defined color change when a certain UV radiation dose is reached.
